(19) United States
(12) Patent Application Publication
(10) Pub. No.: US 2018/0211335 A1
(43) Pub. Date: Jul. 26, 2018

(54) METHOD AND APPARATUS FOR ESTIMATING USER INFLUENCE ON SOCIAL PLATFORM

(71) Applicant: TENCENT TECHNOLOGY (SHENZHEN) COMPANY LIMITED, Shenzhen (CN)

(72) Inventors: Ben TAN, Shenzhen (CN); Dapeng LIU, Shenzhen (CN); Xiaoqing CAO, Shenzhen (CN); Xiaopeng ZHANG, Shenzhen (CN); Lei XIAO, Shenzhen (CN)

(21) Appl. No.: 15/933,891

(22) Filed: Mar. 23, 2018

Related U.S. Application Data
(63) Continuation of application No. PCT/CN2017/070503, filed on Jan. 6, 2017.

(30) Foreign Application Priority Data
Jan. 7, 2016 (CN) 201610009657.3

(51) Int. Cl. G06Q 50/00; H04L 29/08; H04L 12/58; G06Q 30/02

(52) U.S. Cl. CPC G06Q 50/01; G06Q 30/0269; H04L 51/32; H04L 67/22

(57) ABSTRACT

The present disclosure discloses a method and an apparatus for estimating user influence on a social network platform, and a computer storage medium. The method includes: obtaining user behavior data of a number of users on the social network platform; determining an influence transfer relationship between every two users among the number of users according to the user behavior data; estimating an influence-rank of a user of the number of users on the social network platform based on the influence transfer relationship; and determining influence of the user according to the influence-rank.

### CROSS-REFERENCE TO RELATED APPLICATIONS

This patent application is a continuation application of PCT Patent Application No. PCT/CN2017/070503, filed on Jan. 6, 2017, which claims priority to Chinese Patent Application No. 201610009657.3, submitted by Tencent Technology (Shenzhen) Company Limited on Jan. 7, 2016, and entitled “METHOD AND APPARATUS FOR ESTIMATING USER INFLUENCE ON SOCIAL PLATFORM”, entire content of all of which is incorporated herein by reference.

### FIELD OF THE TECHNOLOGY

The present disclosure relates to the field of communications technologies and, in particular, to a method and an apparatus for estimating user influence on a social platform.

### BACKGROUND OF THE DISCLOSURE

With development of Internet technologies, various social applications become increasingly popular. On a social network platform, a person may share his or her feelings, keep up with friends, learn about some hot topics and news, and so on. A large quantity of user data related to social applications, for example, preference of users, social activities of users, and social influence of users (simply referred as user influence), is significant for information placement.

Currently, in a conventional technology, user influence is usually determined based on an interpersonal relationship network. In a social network, a user may add a person that the user likes as a friend or even as a close friend. Therefore, an influence calculation method based on the interpersonal relationship network is to calculate user influence by using a friend coverage degree of the user. A user that has more friends has greater social influence. The user influence describes a capability that a user affects other users. In the field of social network (such as Moments of WeChat), the user influence may be measured by using a degree of attention that the user receives. A user that receives higher degree of attention has greater social influence.

However, with such existing solution for estimating user influence, while social influence of a user can be estimated to some extent, if the user has a large number of friends, but few of them are kept in contact, the social influence of the user obtained only based on the friend coverage degree often has low accuracy and credibility, resulting in inaccurate information placement on social network platforms.

### SUMMARY

An objective of the present disclosure is to provide a method and an apparatus for estimating user influence on a social network platform, so as to improve accuracy and credibility of calculating social influence of a user, thereby improving accuracy of placing information on the social network platform.

To resolve the foregoing technical problems, embodiments of the present disclosure provide the following technical solutions.

One aspect of the present disclosure includes a method for estimating user influence on a social network platform. The method includes: obtaining user behavior data of a number of users on the social network platform; determining an influence transfer relationship between every two users among the number of users according to the user behavior data; estimating an influence-rank of a user of the number of users on the social network platform based on the influence transfer relationship; and determining influence of the user according to the influence-rank.

Another aspect of the present disclosure includes an apparatus for estimating user influence on a social network platform. The apparatus includes a memory storing instructions; and a processor coupled to the memory. When executing the instructions, the processor is configured for: obtaining user behavior data of a number of users on the social network platform; determining an influence transfer relationship between every two users among the number of users according to the user behavior data; estimating an influence-rank of a user of the number of users on the social network platform based on the influence transfer relationship; and determining influence of the user according to the influence-rank.

Another aspect of the present disclosure includes a non-transitory computer-readable storage medium containing computer-executable instructions for, when executed by one or more processors, performing a method for estimating user influence on a social network platform. The method includes: obtaining user behavior data of a number of users on the social network platform; determining an influence transfer relationship between every two users among the number of users according to the user behavior data; estimating an influence-rank of a user of the number of users on the social network platform based on the influence transfer relationship; and determining influence of the user according to the influence-rank.

Other aspects of the present disclosure can be understood by those skilled in the art in light of the description, the claims, and the drawings of the present disclosure.

### BRIEF DESCRIPTION OF THE DRAWINGS

The following describes specific implementations of the present disclosure in detail with reference to the accompanying drawings, and explains the technical solutions and other beneficial effects of the present disclosure.

FIG. 1A illustrates a schematic diagram of an operational environment of a method for estimating user influence on a social network platform according to an embodiment of the present disclosure;

FIG. 1B illustrates a schematic flowchart of a method for estimating user influence on a social network platform according to an embodiment of the present disclosure;

FIG. 2A illustrates a schematic flowchart of a method for estimating user influence on a social network platform according to an embodiment of the present disclosure;

FIG. 2B illustrates a schematic diagram of an application of a method for estimating user influence on a social network platform according to an embodiment of the present disclosure;

FIG. 3A illustrates a schematic structural diagram of an apparatus for estimating user influence on a social network platform according to an embodiment of the present disclosure;

FIG. 3B illustrates another schematic structural diagram of an apparatus for estimating user influence on a social network platform according to an embodiment of the present disclosure; and

FIG. 4 is a structural block diagram of an apparatus according to an embodiment of the present disclosure.

### DETAILED DESCRIPTION

Reference will be made in detail with reference to embodiments of the present disclosure as illustrated in the accompanying drawings and embodiments, and like reference numerals in the drawings may denote same or like elements. It should be understood that, specific embodiments described herein are only for illustrative purposes, and are not intended to limit the scope of the present disclosure. In addition, for ease of description, accompanying drawings only illustrate a part of, but not entire structure related to the present disclosure.

In the following description, the specific embodiments of the present disclosure are described with reference to steps and operations performed by one or more computers, unless otherwise stated. Therefore, it may be understood that these steps and operations are performed by a computer, which are mentioned for several times later, the computer including a computer processing unit manipulating electronic signals that are representative of a structured type of data. This manipulation converts the data or maintains the location of the data in a memory system of the computer, which can be reconfigured, or otherwise a person skilled in this art changes the way of operation of the computer in a well-known manner. The data structure maintained in the physical location of the data in the memory has specific properties defined by the data format. However, the disclosure described in the foregoing text does not lead to any limitation. A person skilled in the art may understand that the various steps and operations described below may also be implemented in hardware.

The disclosure may be made operational with numerous other general purpose or special purpose computing or communication environments or configurations. Examples of well-known computing systems, environments, and configurations that are suitable for use with the present disclosure may include (but are not limited to) handheld telephones, personal computers, servers, multiprocessor systems, microcomputer systems, mainframe computers, and distributed operating environments that include any of the foregoing systems or apparatuses, and the like.

The embodiments of the present disclosure provide a method and an apparatus for estimating user influence on a social network platform.

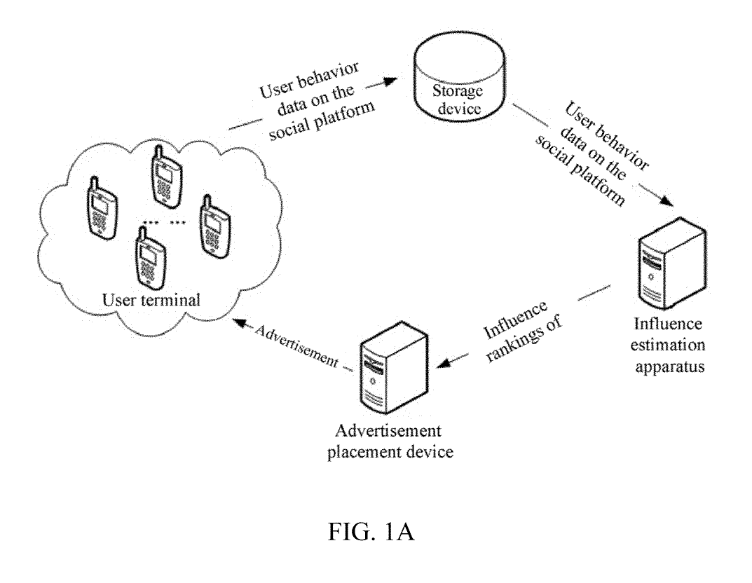

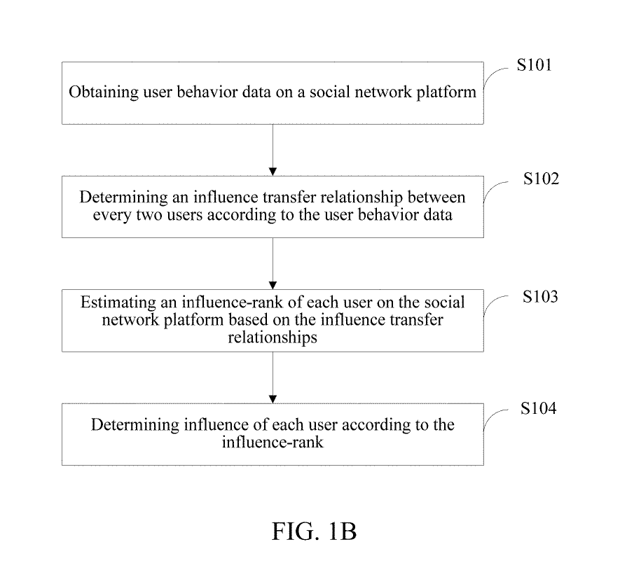

Referring to FIG. 1A, FIG. 1A is a schematic diagram of an operational environment of a method for estimating user influence on a social network platform according to an embodiment of the present disclosure. The operational environment may include an apparatus for estimating user influence on a social network platform, which is referred to as an influence estimation apparatus for short. The apparatus for estimating user influence on a social network platform is mainly configured to: obtain user behavior data on a social network platform, for example, interaction information on the social network platform between a user and messages individually published by a friend of the user, and/or interaction information on the social network platform between the user and advertisement placed by an advertisement placement system; determine an influence transfer relationship between every two users according to the user behavior data; based on the influence transfer relationship, estimate an influence-rank of each user on the social network platform; and, finally, determine influence of each user according to the influence-rank.

In addition, the operational environment may further include a storage device, mainly configured to store the user behavior data on the social network platform, for example, interaction information on the social network platform between a user and messages individually published by a friend of the user, and/or interaction information on the social network platform between the user and advertisement placed by an advertisement placement system, so that the user behavior data can be used by the influence estimation apparatus for processing. Certainly, the operational environment may further include a service device, for example, an advertisement placement device, configured to place an advertisement on a user social network platform according to user influence outputted by the influence estimation apparatus. Detailed descriptions are provided below separately.

In an embodiment, from the perspective of an influence estimation apparatus, the influence estimation apparatus may be specifically integrated into a network device such as a server or a gateway.

A method for estimating user influence on a social network platform includes: obtaining user behavior data on a social network platform; determining an influence transfer relationship between every two users according to the user behavior data; estimating an influence-rank of each user on the social network platform based on the influence transfer relationship; and determining the influence of each user according to the influence-rank.

Referring to FIG. 1B, FIG. 1B is a schematic flowchart of the method for estimating user influence on a social network platform according to an embodiment of the present disclosure. The method may include the followings.

S101. Obtaining user behavior data on a social network platform.

S102. Determining an influence transfer relationship between every two users according to the user behavior data.

The social network platform may specifically include WeChat (friend circle or Moments), Microblog, QQ Space, or the like. On the social network platform, a user may share his or her feelings, keep up with friends, learn about some hot topics and news, and so on.

In some implementations, each social network platform may be set to correspond to one database. The influence estimation apparatus may obtain user behavior data on a corresponding social network platform from these databases. In some implementations, data on all social network platforms may be organized, and the influence estimation apparatus may obtain user behavior data therefrom. No specific limitation is intended herein.

Specifically, for example, the process of determining an influence transfer relationship between every two users according to the user behavior data includes the followings.

1. Generating an influence transfer matrix according to the obtained user behavior data.

2. Determining the influence transfer relationship between every two users according to the influence transfer matrix.

That is, for example, the influence transfer relationship between the users may be described by using an influence transfer matrix W□R̂^{(n×n)}. Elements in the influence transfer matrix element indicate the influence transfer relationship between every two users, that is, indicate influence of one user upon another user.

It may be understood that, on the social network platform (for example, WeChat), user influence is a capability that a user changes and attracts a behavior of another user. A user that has greater influence gains more attention of his or her friends, information published by the user obtains more comments and likes, and the information viewpoint of the user spreads faster.

Further, multiple ways may be used to generate the influence transfer matrix according to the user behavior data. For example, the followings may be specifically included.

11. Based on the user behavior data, determining first interaction information and second interaction information.

The first interaction information is information about interaction on the social network platform between a user and messages individually published by a friend of the user, and the second interaction information is information about interaction on the social network platform between the user and advertisement placed by an advertisement placement system.

12. Generating the influence transfer matrix according to the first interaction information and the second interaction information.

That is, the user behavior data in this embodiment of the present disclosure may include information about interactions between the user and the message(s) individually published by a friend of the user (that is, the first interaction information), and information about interactions between the user and the advertisement placed by the advertisement placement system (that is, the second interaction information). The influence estimation apparatus generates the influence transfer matrix according to the first interaction information and the second interaction information, so as to determine the influence transfer relationships among users of the social network platform.

For example, if influence of a user A upon a user B needs to be determined, in the friend circle of WeChat, the first interaction information may be specifically the number of comments (or likes) that are made by the user B on messages published by the user A, and the second interaction information may be specifically the number of comments (or likes) that are subsequently made by the user B on advertisements on which the user A has made a comment (or like).

Further, in a process of generating the influence transfer matrix, the following parameters further need to be determined. For example, the first interaction information may further include the number of times of interactions of the user B with messages individually published by all friends of the user B, and the second interaction information may further include the number of times of interactions of the user B with all advertisements that the friends of the user B interact with. In addition, an importance weight value P of user information in the friend circle and an importance weight value Q of interaction performed by a friend with an advertisement in the friend circle further need to be determined and set, so as to obtain the influence of the user A upon the user B with reference to an importance weight value P of the first interaction information and an importance weight value Q of the second interaction information.

Similarly, an influence transfer relationship between other two users may also be determined in the foregoing manner, so that the influence transfer matrix is constructed. In addition, specific values of the importance weight values P and Q in this embodiment may be determined according to an attention rate in an actual application scenario. No specific limitation is intended herein.

S103. Estimating an influence-rank of a user or each user on the social network platform based on the influence transfer relationships.

S104. Determining influence of the user or each user according to the influence-rank.

It may be understood that, the influence transfer matrix represents the influence transfer relationship between every two users and, in this embodiment, influence of all the users in an entire social network may need to be ranked (e.g., influence ranking of the users). Therefore, in this embodiment, an influence-rank of a user may be estimated by using a concept of a PageRank algorithm as reference.

PageRank is an algorithm that was designed to measure importance of a particular web page relative to another web page in a search engine, and a calculation result of PageRank is an important indicator for a web page ranking in a Google search result.

Because web pages are connected to each other by using hyperlinks, numerous web pages on the Internet constitute a huge graph. It is assumed in PageRank that a user randomly selects a web page from all web pages for view, and then keeps jumping between web pages by using hyperlinks. After landing on each web page, the user has two choices: ending therein or continuing to select another link for view. In the algorithm, a probability that the user continues to view a web page is set to ‘d’, and the user randomly selects, at the equal probability, one from all hyperlinks on a current page for continuous view. This may be considered as a random-walk process. After multiple such walks, a probability that each web page is visited or accessed by a visiting user is converged to a stable value. The probability is an importance indicator of the web page, and is used for web page ranking.

As described above, numerous web pages on the Internet constitute a huge graph. Each node in the graph is a web page, and a hyperlink is an edge of the graph. In the graph, PageRank performs web page ranking by means of a random-walk process. Based on PageRank, the social network may also constitute a huge graph. Each node in the graph represents a user, and an interaction relationship between users is considered as an edge of the graph. The PageRank algorithm may be applied to the graph constituted by the social network, to obtain user ranking and calculate user influence.

In this embodiment, the process of estimating an influence-rank of a user on the social network platform based on the influence transfer relationship may include the followings.

a. Obtaining an initial influence-rank and a historical influence-rank of the user on the social network platform, where the historical influence-rank is an influence-rank of the user on the social network platform at a previous moment.

b. Using a preset web page ranking algorithm, and based on the influence transfer relationship, the initial influence-rank, and the historical influence-rank, estimating a current influence-rank by, where the current influence-rank is an influence-rank of the user on the social network platform at a current moment.

It may be understood that, based on the concept of PageRank, a random-walk-based influence pre-estimation algorithm may be designed for the social network. As time goes by, the influence-rank of the user on the social network platform changes. In the influence pre-estimation algorithm, the initial influence-rank of the user and the influence-rank of the user on the social network platform at the previous moment (which may be referred to as the historical influence-rank) need to be determined before the current influence-rank of the user is calculated.

Further, after the current influence-rank is estimated, the current influence-rank further needs to be analyzed, so as to determine a final influence-rank of the user, as described below.

c. Estimating the final influence-rank of the user according to the historical influence-rank and the current influence-rank.

d. Determining the final influence-rank as an influence-rank of the user on the social network platform.

Specifically, the process of estimating a final influence-rank of the user according to the historical influence-rank and the current influence-rank includes: determining the current influence-rank as an estimation result of the final influence-rank if a difference between the historical influence-rank and the current influence-rank satisfies a preset convergence condition.

That is, for each user, as time goes by, the influence-rank of the user on the social network platform is converged to a stable value, and the value is the estimation result of the final influence-rank. An influence value of each user on the social network platform may be determined by using the influence-rank estimation result.

As may be learned above, in the method for estimating user influence on a social network platform provided in this embodiment of the present disclosure, an influence transfer relationship between every two users is first determined according to user behavior data on a social network platform, and then an influence-rank of each user on the social network platform is estimated based on the influence transfer relationships, so that user influence can be determined according to the influence-rank. User behavior data mainly indicates interaction information of users in a social network activity. The influence transfer relationship between the users is mainly determined according to the user behavior data, and user influence is estimated based on the influence transfer relationship. Therefore, in comparison with an existing method in which social influence of a user is measured only based on a friend coverage degree, accuracy and credibility of estimating social influence of a user are greatly improved, and accuracy of placing information on a social network platform is also improved.

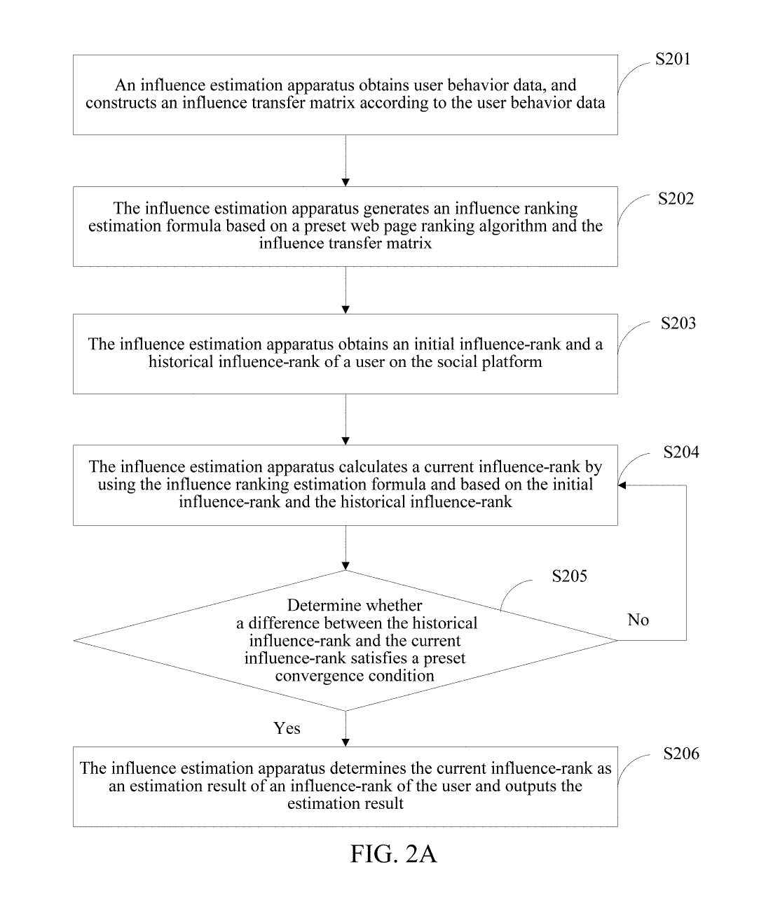

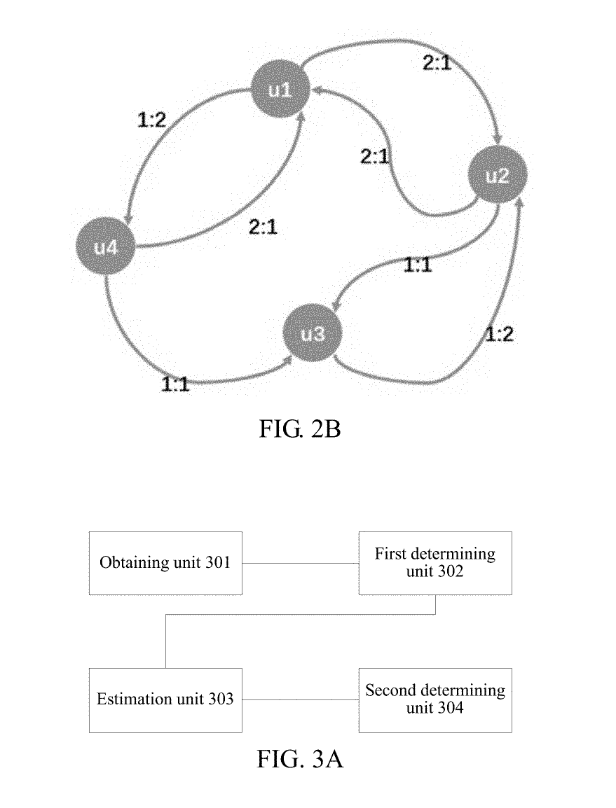

Referring to FIG. 2A, FIG. 2A is a schematic flowchart of the method for estimating user influence on a social network platform according to the present disclosure. Specifically, the method may include the followings.

S201. An influence estimation apparatus obtains user behavior data, and constructs an influence transfer matrix according to the user behavior data.

Specifically, based on a concept of PageRank, a social network may constitute a network graph. Each node in the network graph represents a user, and an interaction relationship between two users is considered as an edge of the network graph connecting the two nodes representing the two users (i.e., two neighboring users).

For example, on a social network platform of a friend circle of WeChat, interaction between users constitutes a huge network G={V,E}, where a node is V=∴u₁, u_{2,} . . . , uₙ}, n is a number of the users, and an edge is E={eᵢⱼ|uᵢ and uⱼ are friends}. Based on such a network structure, an influence transfer matrix W□R̂^{(n×n)} is constructed according to first interaction information and second interaction information. The first interaction information is information about interaction on the social network platform between a user and messages individually published by a friend of the user, and the second interaction information is information about interaction on the social network platform between the user and advertisement placed by an advertisement placement system.

Further, an element in the influence transfer matrix may be determined according to the following formula:

$$w ( i , j ) = \frac{α {C}_{ij} + β {A}_{ij}}{α {\sum }_{k ∈ N ( {u}_{j} )} {C}_{kj} + β {\sum }_{k ∈ N ( {u}_{j} )} {A}_{kj}} \qquad ( 1 )$$

where Cᵢⱼ is the number of comments (or likes) that are made by a user j on messages published by a user i, Aᵢⱼ is the number of comments (or likes) that are subsequently made by the user j on advertisements on which the user i has made a comment (or like), k□N(uⱼ) includes all neighbors and friends of the user j, and α and β are respectively an importance weight value of user information in the friend circle and an importance weight value of interaction performed by a friend with an advertisement in the friend circle. Because in general more attention is paid on the influence of a user upon an advertisement, usually α<β.

S202. The influence estimation apparatus generates an influence-rank estimation formula based on a preset web page ranking algorithm and the influence transfer matrix.

S203. The influence estimation apparatus obtains an initial influence-rank and a historical influence-rank of each user on the social network platform.

S204. The influence estimation apparatus calculates a current influence-rank by using the influence-rank estimation formula and based on the initial influence-rank and the historical influence-rank.

S205. The influence estimation apparatus determines whether a difference between the historical influence-rank and the current influence satisfies a preset convergence condition. If yes, S206 is performed; or if not, S204 is performed again.

S206. The influence estimation apparatus determines the current influence-rank as an estimation result of an influence-rank of the user and outputs the estimation result.

Specifically, in S202 to S206, an element w(i,j) in the influence transfer matrix describes influence of the user i upon the user j, that is, a probability that the user j focuses on a message of the user i. That is, w(i,j) describes an influence transfer relationship between every two users, and in this embodiment of the present disclosure, an influence-rank of each user in an entire social network needs to be obtained. Therefore, based on the concept of PageRank, a random-walk-based influence pre-estimation algorithm (that is, an influence-rank estimation formula) is designed for a social network G. A calculation formula of the algorithm is as follows:

I₍ₜ₊₁₎=bWIₜ+(1−b)I₀ (2)

Iₜ□R̂^{(1×n)} is a vector, and describes influence-ranks of all the users at a moment t. When t=0, a value of each element of I₀ is equal to 1/n. b is an adjustable hyperparameter, and is set according to an empirical value. Usually, b is set between 0.8 and 0.9.

As may be learned from the formula (2), if the current influence-rank (that is, I₍ₜ₊₁₎) needs to be obtained, the initial influence-rank (that is, I₀) and the historical influence-rank (that is, an influence-rank Iₜ at a previous moment) of the user on the social network platform need to be first obtained. Subsequently, it is determined whether the difference between the historical influence-rank and the current influence satisfies the preset convergence condition, and if yes, the current influence-rank is determined as the estimation result of influence-rank of the user(s) and the estimation result is outputted.

That is, in the formula (2), for each random user, a node of the user with 1/n of an influence value accesses a neighboring node along an edge of the network at an influence transfer probability in the matrix W, and transfers influence to the neighbor in proportion. As time goes by, an influence value Iₜ of each user is converged to a stable value, and the value is a final influence-rank of the user.

To better understand the technical solution of the present disclosure, a specific application is used below as an example for analysis and description.

Further referring to FIG. 2B, FIG. 2B is a schematic diagram of interactions between friends in this embodiment. It is assumed that an interaction network of the friend circle of WeChat includes four users, and interactions between the users is shown in FIG. 2B. Nodes u1, u2, u3, and u4 represent the four users, and directed edges represent the interaction between two users.

For example, a directed edge u4→u1 represents a behavior of the user u4 towards the user u1, and two numbers on the edge respectively represent that the user u4 praises two messages published by the user u1, and that the user u4 makes one follow-up comment on an advertisement on which the user u1 has made a comment.

In the formula (1), for ease of calculation, it may set in this embodiment that α=0.5, and β=0.5. Then, the influence transfer matrix obtained through calculation based on the formula (1) is:

$$W = \begin{matrix}0 & 0.6 & 0 & 0.6 \\ 0.5 & 0 & 1 & 0 \\ 0 & 0.4 & 0 & 0.4 \\ 0.5 & 0 & 0 & 0\end{matrix}$$

Subsequently, based on the formula (2), it is first initialized that I₀=(0.25, 0.25, 0.25, 0.25), and it may be set that b=0.85. Next, W, I₀, and b are substituted for an iterative operation. In this way, as time goes by, the influence-rank Iₜ of the user is converged to a stable value, and the value is the final influence-rank of the user. It may be learned from the iterative operation that, obtained final influence-ranks of the users are Iₜ=(1.29, 1.33, 0.87, 1.13). Therefore, it may be seen that influence of the user u₂ is the greatest, and influence of the user u₃ is the smallest.

If the method for estimating user influence on a social network platform provided in this embodiment of the present disclosure is applied to user influence calculation of WeChat, an influence transfer matrix is constructed with reference to interaction records on advertisements in a friend circle of users and on personal information in the friend circle of the users, and a random-walk algorithm is designed, to implement user influence pre-estimation. Further, a result of the user influence pre-estimation is applied to advertisement placement in the friend circle. An advertisement may be preferentially placed to users with great influence, and after receiving comments or likes made by these users, an advertisement system places the advertisement to friends of the users with great influence. Therefore, an advertisement interaction rate can be greatly improved, thereby achieving a better advertisement benefit.

Accordingly, in the method for estimating user influence on a social network platform provided in this embodiment of the present disclosure, an influence transfer relationship between every two users is first determined according to user behavior data on a social network platform, and then an influence-rank of each user on the social network platform is estimated based on the influence transfer relationship, so that user influence can be determined according to the influence-rank. User behavior data mainly indicates interaction information of users in a social network activity. The influence transfer relationship between the users is mainly determined according to the user behavior data, and user influence is estimated based on the influence transfer relationship. Therefore, in comparison with an existing method in which social influence of a user is measured only based on a friend coverage degree, accuracy and credibility of estimating social influence of a user are greatly improved, and accuracy of placing information on a social network platform is also improved.

To better perform the method for estimating user influence on a social network platform provided in the embodiments of the present disclosure, an embodiment of the present disclosure further provides an apparatus based on the foregoing method for estimating user influence on a social network platform. For details of a specific implementation, refer to the descriptions in the method embodiments.

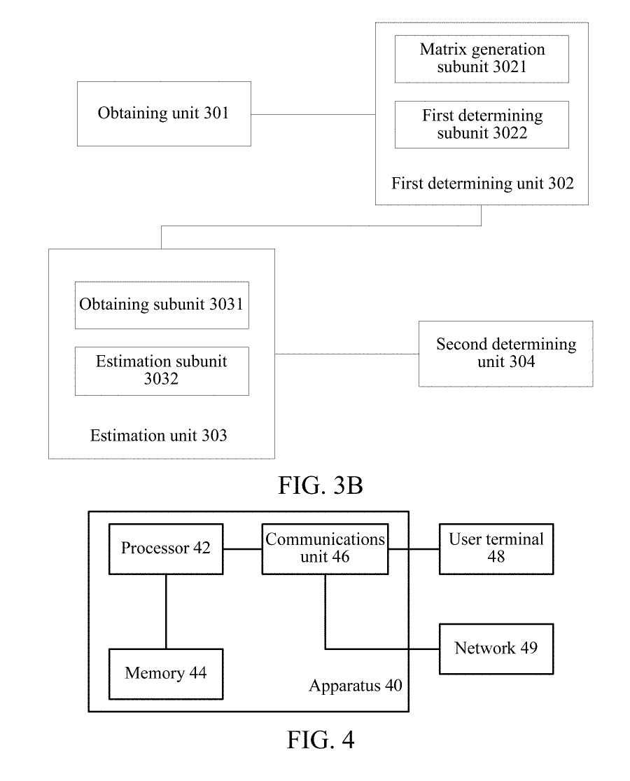

Referring to FIG. 3A, FIG. 3A is a schematic structural diagram of an apparatus for estimating user influence on a social network platform according to an embodiment of the present disclosure. The apparatus may include an obtaining unit 301, a first determining unit 302, an estimation unit 303, and a second determining unit 304.

The obtaining unit 301 is configured to obtain user behavior data on a social network platform. The first determining unit 302 is configured to determine an influence transfer relationship between every two users according to the user behavior data.

In this embodiment of the present disclosure, the social network platform may specifically include Friend Circle of WeChat, Microblog, QQ Space, or the like. On the social network platform, a user may share his or her feelings, keep up with friends, learn about some hot topics and news, and so on.

In some implementations, each social network platform may be set to correspond to one database. The influence estimation apparatus may obtain user behavior data on a corresponding social network platform from these databases. In some implementations, data on all social network platforms may be organized, and the influence estimation apparatus may obtain user behavior data therefrom. No specific limitation is intended herein.

It may be understood that, on the social network platform (for example, WeChat), user influence is a capability that a user changes and attracts a behavior of another user. A user that has greater influence gains more attention of his or her friends, information published by the user obtains more comments and likes, and an information viewpoint of the user spreads faster.

An influence transfer matrix describes an influence transfer relationship between every two users and, in this embodiment, influence of all the users in an entire social network needs to be ranked. Therefore, in this embodiment, an influence-rank of each user may be estimated by using the PageRank algorithm.

The estimation unit 303 is configured to estimate an influence-rank of each user on the social network platform based on the influence transfer relationship. The second determining unit 304 is configured to determine influence of each user according to the influence-rank.

Further referring to FIG. 3B, FIG. 3B is a schematic structural diagram of an apparatus for estimating user influence on a social network platform according to an embodiment of the present disclosure. The first determining unit 302 may specifically include a matrix generation subunit 3021, and a first determining subunit 3022. The matrix generation subunit 3021 is configured to generate an influence transfer matrix according to the user behavior data; and the first determining subunit 3022 is configured to determine the influence transfer relationship between every two users according to the influence transfer matrix.

That is, for example, the influence transfer relationship between the users may be described by using an influence transfer matrix W□R̂^{(n×n)}. Elements in the influence transfer matrix element indicate the influence transfer relationship between every two users, that is, indicate influence of one user upon another user.

Further, the matrix generation subunit 3021 may be specifically configured to: determine, based on the user behavior data, first interaction information and second interaction information, where the first interaction information is information about interaction on the social network platform between a user and a message(s) individually published by a friend, and the second interaction information is information about interaction on the social network platform between the user and an advertisement placed by advertisement placement system; and generate the influence transfer matrix according to the first interaction information and the second interaction information.

That is, the user behavior data in the embodiments of the present disclosure may include information about interaction between a user and a message(s) individually published by a friend (that is, the first interaction information), and information about interaction between the user and the advertisement placed by the advertisement placement system (that is, the second interaction information). The influence estimation apparatus generates the influence transfer matrix according to the first interaction information and the second interaction information, so as to determine the influence transfer relationship between the users.

For example, if influence of a user A upon a user B needs to be determined, in the friend circle of WeChat, the first interaction information may be specifically the number of comments (or likes) that are made by the user B on messages published by the user A, and the second interaction information may be specifically the number of comments (or likes) that are subsequently made by the user B on advertisements on which the user A has made a comment (or like).

Further, in a process of generating the influence transfer matrix, the following parameters further need to be determined. For example, the first interaction information may further include the number of times of interactions of the user B with messages individually published by all friends of the user B, and the second interaction information may further include the number of times of interactions of the user B with all advertisements that the friends of the user B perform interaction with. In addition, an importance weight value P of user information in the friend circle and an importance weight value Q of interaction performed by a friend with an advertisement in the friend circle further need to be determined and set, so as to obtain the influence of the user A upon the user B with reference to an importance weight value P of the first interaction information and an importance weight value Q of the second interaction information.

Accordingly, an influence transfer relationship between other two users may also be determined in the foregoing manner, so that the influence transfer matrix is constructed. In addition, specific values of the importance weight values P and Q in this embodiment may be determined according to an attention rate in an actual application scenario. No specific limitation is intended herein.

Based on the foregoing description, in this embodiment, the estimation unit 303 may specifically include an obtaining subunit 3031, and an estimation subunit 3032. The obtaining subunit 3031 is configured to obtain an initial influence-rank and a historical influence-rank of the user on the social network platform, where the historical influence-rank is an influence-rank of the user on the social network platform at a previous moment.

The estimation subunit 3032 is configured to estimate a current influence-rank by using a preset webpage ranking algorithm and based on the influence transfer relationship, the initial influence-rank, and the historical influence-rank, where the current influence-rank is an influence-rank of the user on the social network platform at a current moment.

It may be understood that, based on a concept of PageRank, a random-walk-based influence pre-estimation algorithm may be designed for a social network. As time goes by, the influence-rank of the user on the social network platform changes. In the influence pre-estimation algorithm, the initial influence-rank of the user and the influence-rank of the user on the social network platform at the previous moment (which may be referred to as the historical influence-rank) need to be determined before the current influence-rank of the user is calculated.

Further, the estimation subunit 3032 is further configured to analyze the current influence-rank, to determine a final influence-rank of the user. For example, the estimation subunit 3032 may be further configured to: estimate the final influence-rank of the user according to the historical influence-rank and the current influence-rank, and determine the final influence-rank as an influence-rank of the user on the social network platform.

Specifically, the estimation subunit 3032 may be further configured to: determine the current influence-rank as an estimation result of the final influence-rank if a difference between the historical influence-rank and the current influence satisfies a preset convergence condition.

That is, for each user, as time goes by, the influence-rank of the user on the social network platform is converged to a stable value, and the value is the estimation result of the final influence-rank. An influence value of each user on the social network platform may be determined by using the influence-rank estimation result.

In a specific implementation, the foregoing units may be implemented as independent entities, or may be combined arbitrarily, or may be implemented as a same entity or several entities. For specific implementations of the foregoing units, refer to the foregoing method embodiments. Details are not described herein again.

The apparatus for estimating user influence on a social network platform may be specifically integrated into a network device such as a server or a gateway.

As may be learned above, according to the apparatus for estimating user influence on a social network platform provided in the embodiment of the present disclosure, an influence transfer relationship between every two users is first determined according to user behavior data on a social network platform, and then an influence-rank of a user on the social network platform is estimated based on the influence transfer relationship, so that user influence can be determined according to the influence-rank. User behavior data mainly indicates interaction information of users in a social network activity. The influence transfer relationship between the users is mainly determined according to the user behavior data, and user influence is estimated based on the influence transfer relationship. Therefore, in comparison with an existing manner in which social influence of a user is measured only based on a friend coverage degree, accuracy and credibility of estimating social influence of a user are greatly improved, and accuracy of placing information on a social network platform is also improved.

In the foregoing embodiments, the description of each embodiment has respective focuses. For a part that is not described in detail in an embodiment, refer to a detailed description in the foregoing method for estimating user influence on a social network platform. Details are not described herein again.

The apparatus for estimating user influence on a social network platform provided in the embodiments of the present disclosure is, for example, a computer, a tablet computer, or a mobile phone having a touch function. The apparatus for estimating user influence on a social network platform and the method for estimating user influence on a social network platform in the foregoing embodiments belong to a same concept. Any method provided in the embodiments of the method for estimating user influence on a social network platform may be running on the apparatus for estimating user influence on a social network platform. For details of a specific implementation, refer to the embodiments of the method for estimating user influence on a social network platform. Details are not described herein again.

It should be noted that, for the method for estimating user influence on a social network platform of the present disclosure, a person of ordinary skills in the art may understand that all or some procedures of the method for estimating user influence on a social network platform may be implemented by using a computer program by controlling related hardware. The computer program may be stored in a computer readable storage medium, for example, stored in a memory of a terminal, and be executed by at least one processor in the terminal. When the computer program is running, the procedures of the method for estimating user influence on a social network platform in the embodiments are performed. The foregoing storage medium may include: a magnetic disk, an optical disc, a read-only memory (ROM), or a random access memory (RAM).

The modules of the apparatus for estimating user influence on a social network platform in the embodiments of the present disclosure may be integrated into one processing chip, or each of the modules may exist alone physically, or two or more modules are integrated into one module. The integrated module may be implemented in a form of hardware, or may be implemented in a form of a software functional module. When the integrated module is implemented in the form of a software functional module and sold or used as an independent product, the integrated unit may be stored in a computer readable storage medium. The storage medium is, for example, an ROM, a magnetic disk, or an optical disc.

FIG. 4 illustrates an exemplary apparatus 40. As shown in FIG. 4, apparatus 40 may include a processor 42 and a memory 44, and optionally, includes a communications unit 46. The processor 42 may be considered as a control unit of the apparatus, and the processor 42 is connected to other components by using an interface or a line in a wired or wireless manner.

In an implementation, the processor 42 may be connected to the memory 44 by using a data bus. The processor 42 may be connected to a user terminal 48 or a network 49 by using an interface (which may be a wired interface or a wireless interface) or a communications unit 46 in a wired or wireless manner, to implement data exchange and communication with the external. Similarly, the memory 44 may include but is not limited to: a ROM, a RAM, a CD-ROM, another erasable memory, or the like. The memory 44 stores program code, functional modules, or the like. Specifically, the memory 44 stores a computer program or a functional module. When the processor 42 invokes and executes, by accessing the memory 44, the computer program or the functional module stored in the memory 44, the operation of the method or apparatus according to any embodiment of the present disclosure may be implemented.

The foregoing provides detailed descriptions of the method and apparatus for estimating user influence on a social network platform provided in the embodiments of the present disclosure. In this specification, specific examples are used to describe the principle and implementations of the present disclosure, and the descriptions of the embodiments are only intended to help understand the method and core idea of the present disclosure. Meanwhile, a person of skilled in the art may, based on the idea of the present disclosure, make modifications with respect to the specific implementations and the application scope. Therefore, the content of this specification shall not be construed as a limitation to the present disclosure.

What is claimed is:

1. A method for estimating user influence on a social network platform, comprising:
obtaining user behavior data of a number of users on the social network platform;
determining an influence transfer relationship between every two users among the number of users according to the user behavior data;
estimating an influence-rank of a user of the number of users on the social network platform based on the influence transfer relationship; and
determining influence of the user according to the influence-rank.

2. The method for estimating user influence on a social network platform according to claim 1, wherein the determining an influence transfer relationship between every two users among the number of users according to the user behavior data comprises:
generating an influence transfer matrix according to the user behavior data; and
determining the influence transfer relationship between every two users according to the influence transfer matrix.

3. The method for estimating user influence on a social network platform according to claim 2, wherein the generating an influence transfer matrix according to the user behavior data comprises:
determining, based on the user behavior data, first interaction information and second interaction information, wherein the first interaction information is information about interaction on the social network platform between a user and a message individually published by a friend of the user, and the second interaction information is information about interaction on the social network platform between the user and an advertisement placed by an advertisement placement system; and
generating the influence transfer matrix according to the first interaction information and the second interaction information.

4. The method for estimating user influence on a social network platform according to claim 1, wherein the estimating an influence-rank of the user comprises:
obtaining an initial influence-rank and a historical influence-rank of the user on the social network platform, wherein the historical influence-rank is an influence-rank of the user on the social network platform at a previous moment; and
estimating a current influence-rank by using a preset web page ranking algorithm and based on the influence transfer relationship, the initial influence-rank, and the historical influence-rank, wherein the current influence-rank is an influence-rank of the user on the social network platform at a current moment.

5. The method for estimating user influence on a social network platform according to claim 4, after the estimating a current influence-rank, further comprising:
estimating a final influence-rank of the user according to the historical influence-rank and the current influence-rank; and
determining the final influence-rank as an influence-rank of the user on the social network platform.

6. The method for estimating user influence on a social network platform according to claim 5, wherein the estimating a final influence-rank of the user according to the historical influence-rank and the current influence-rank comprises:
determining the current influence-rank as an estimation result of the final influence-rank if a difference between the historical influence-rank and the current influence satisfies a preset convergence condition.

7. An apparatus for estimating user influence on a social network platform, comprising:
a memory storing instructions; and
a processor coupled to the memory and, when executing the instructions, configured for:
obtaining user behavior data of a number of users on the social network platform;
determining an influence transfer relationship between every two users among the number of users according to the user behavior data;
estimating an influence-rank of a user of the number of users on the social network platform based on the influence transfer relationship; and
determining influence of the user according to the influence-rank.

8. The apparatus for estimating user influence on a social network platform according to claim 7, wherein, for determining an influence transfer relationship between every two users among the number of users according to the user behavior data, the processor is further configured for:
generating an influence transfer matrix according to the user behavior data; and
determining the influence transfer relationship between every two users according to the influence transfer matrix.

9. The apparatus for estimating user influence on a social network platform according to claim 8, wherein, for generating an influence transfer matrix according to the user behavior data, the processor is further configured for:
determining, based on the user behavior data, first interaction information and second interaction information, wherein the first interaction information is information about interaction on the social network platform between a user and a message individually published by a friend of the user, and the second interaction information is information about interaction on the social network platform between the user and an advertisement placed by an advertisement placement system; and
generating the influence transfer matrix according to the first interaction information and the second interaction information.

10. The apparatus for estimating user influence on a social network platform according to claim 7, wherein, for estimating an influence-rank of the user, the processor is further configured for:
obtaining an initial influence-rank and a historical influence-rank of the user on the social network platform, wherein the historical influence-rank is an influence-rank of the user on the social network platform at a previous moment; and
estimating a current influence-rank by using a preset web page ranking algorithm and based on the influence transfer relationship, the initial influence-rank, and the historical influence-rank, wherein the current influence-rank is an influence-rank of the user on the social network platform at a current moment.

11. The apparatus for estimating user influence on a social network platform according to claim 10, wherein, after the estimating a current influence-rank, the processor is further configured for:
estimating a final influence-rank of the user according to the historical influence-rank and the current influence-rank; and
determining the final influence-rank as an influence-rank of the user on the social network platform.

12. The apparatus for estimating user influence on a social network platform according to claim 11, wherein, for estimating a final influence-rank of the user according to the historical influence-rank and the current influence-rank, the processor is further configured for:
determining the current influence-rank as an estimation result of the final influence-rank if a difference between the historical influence-rank and the current influence satisfies a preset convergence condition.

13. A non-transitory computer-readable storage medium containing computer-executable instructions for, when executed by one or more processors, performing a method for estimating user influence on a social network platform, the method comprising:
obtaining user behavior data of a number of users on the social network platform;
determining an influence transfer relationship between every two users among the number of users according to the user behavior data;
estimating an influence-rank of a user of the number of users on the social network platform based on the influence transfer relationship; and
determining influence of the user according to the influence-rank.

14. The non-transitory computer-readable storage medium according to claim 13, wherein the determining an influence transfer relationship between every two users among the number of users according to the user behavior data comprises:
generating an influence transfer matrix according to the user behavior data; and
determining the influence transfer relationship between every two users according to the influence transfer matrix.

15. The non-transitory computer-readable storage medium according to claim 14, wherein the generating an influence transfer matrix according to the user behavior data comprises:
determining, based on the user behavior data, first interaction information and second interaction information, wherein the first interaction information is information about interaction on the social network platform between a user and a message individually published by a friend of the user, and the second interaction information is information about interaction on the social network platform between the user and an advertisement placed by an advertisement placement system; and
generating the influence transfer matrix according to the first interaction information and the second interaction information.

16. The non-transitory computer-readable storage medium according to claim 13, wherein the estimating an influence-rank of the user comprises:
obtaining an initial influence-rank and a historical influence-rank of the user on the social network platform, wherein the historical influence-rank is an influence-rank of the user on the social network platform at a previous moment; and
estimating a current influence-rank by using a preset web page ranking algorithm and based on the influence transfer relationship, the initial influence-rank, and the historical influence-rank, wherein the current influence-rank is an influence-rank of the user on the social network platform at a current moment.

17. The non-transitory computer-readable storage medium according to claim 16, after the estimating a current influence-rank, further comprising:
estimating a final influence-rank of the user according to the historical influence-rank and the current influence-rank; and
determining the final influence-rank as an influence-rank of the user on the social network platform.

18. The non-transitory computer-readable storage medium according to claim 17, wherein the estimating a final influence-rank of the user according to the historical influence-rank and the current influence-rank comprises:
determining the current influence-rank as an estimation result of the final influence-rank if a difference between the historical influence-rank and the current influence satisfies a preset convergence condition.
